(19) United States
(12) Patent Application Publication
(10) Pub. No.: US 2017/0327399 A1
(43) Pub. Date: Nov. 16, 2017

(54) SLUDGE TREATMENT DEVICE AND METHOD

(71) Applicant: INSTITUT NATIONAL DE RECHERCHE EN SCIENCES ET TECHNOLOGIES POUR L'ENVIRONNEMENT ET L'AGRICULTURE, Antony (FR)

(72) Inventors: Jean-Christophe BAUDEZ, Monestier (FR); Fabrice DANJOUX, Chateauroux (FR); Emilie DIEUDE-FAUVEL, Saint Pourcain sur Sioule (FR); Denis MICLET, Varennes sur Allier (FR)

(21) Appl. No.: 15/536,454

(22) PCT Filed: Dec. 21, 2015
(86) PCT No.: PCT/FR2015/053690

§ 371 Date: Jun. 15, 2017

(30) Foreign Application Priority Data
Dec. 19, 2014 (FR) 14 62990

(51) Int. Cl. C02F 11/14

(52) U.S. Cl. CPC C02F 11/14; C02F 2209/00

(57) ABSTRACT

The invention relates to a device and method for the treatment of sludge with a powder additive, in a co-rotating twin-screw extruder having a length/diameter ratio of less than 20 and comprising a control means allowing the feed flow of powder additive to be adjusted according to the sludge feed flow.

This invention relates to a device and method for the treatment of sludge with a powder additive, such as lime in particular, in a co-rotating twin-screw extruder having a length/diameter ratio of less than 20 and comprising a control means allowing the feed flow of powder additive to be adjusted according to the sludge feed flow. The device and method of this invention apply in particular to sewage sludge after dewatering thereof.

### STATE OF THE ART

It is known to treat sewage sludge with a powder additive, such as lime in particular. This operation, known by the name of liming when the powder additive is lime, allows a hygienization of the material, a reduction of odor, an improvement in the possibility of handling, a neutralization of metal trace elements and an increase in agronomic value.

To be precise, quicklime reacts with the water contained in the sludge, which has the effect, on the one hand, of increasing the temperature because the reaction is exothermic, and on the other, of reducing the water content by converting the quicklime into slaked lime.

According to current health regulations, sludge is hygienized when its pH remains above 12 for the entire duration of storage and the reaction temperature has been above 55° C. for 75 minutes or any other equivalent time/temperature pairing (such as 58° C. for 5 minutes). In known methods, the mixture of lime and sludge is achieved using relatively basic tools, either with the aid of a single screw or with the aid of special paddle mixers or coulters and the final result is often coarse, with a very heterogeneous mixture. This heterogeneity of the mixture implies a heterogeneity of the action of the lime on the pathogenic organisms: at low doses, the pH is not uniformly equal to 12 and reversals of fermentation are often observed. Also, in order to comply with legislation, overdosing is frequent.

Expressed in terms of dose of slaked lime, which represents about 1.3 times the dose of quicklime, the minimum levels currently required are around 30%. However, in order to ensure long-term storage, and avoid reversals of fermentation, these concentrations very often reach 50%, or even 60% in certain cases. These overdoses lead to a sharp increase in the operating costs of water treatment plants, which have a tangible impact on customers' water bills.

In French patent FR 2 940 800, the Applicant described a sludge treatment method in a co-rotating twin-screw extruder. The device used in this method was not, however, suitable for use in a water treatment plant. In fact, it is desirable that the device should be small and movable so as to meet the specific requirements of small installations, like rural water treatment plants.

The present inventors have found that a co-rotating twin-screw extruder having a length/diameter ratio of less than 20 guarantees a high quality mixture while being of a compact size. Moreover, the device perfected by the present inventors allows the quantity of powder additive used to treat the sludge to be limited, thanks to the method of introducing said powder additive into the device and the control of its flow according to the flow and quality of the sludge to be treated.

### SUMMARY OF THE INVENTION

The subject matter of the invention concerns a device for the treatment of sludge with a powder additive, said device comprising:
a sleeve enclosing two co-rotating screws, said screws of said sleeve consisting of two or three successive zones: the first zone ensuring the mixture of the sludge and powder additive; the second zone located downstream of the first zone ensuring the conveyance of the mixture of sludge and powder additive; a third zone, if any, located upstream of the first zone, ensuring the conveyance of the sludge from the sludge feed inlet to the first zone;
a sludge feed inlet emerging upstream of the first zone or third zone, if any;
a powder additive feed inlet emerging at the first zone or third zone, if any;
an outlet for the mixture of sludge and powder additive downstream of the second zone;
a control means allowing the powder additive feed flow to be adjusted according to the sludge feed flow;
said device having a length/diameter ratio of less than 20, preferably less than 14, more preferably less than 10.
The subject matter of the invention also relates to a method for the treatment of sludge by extrusion, advantageously being implemented with the device according to the invention, said method comprising the following steps:
   introduction of sludge into a co-rotating twin-screw extruder;
   introduction of a powder additive in the extruder downstream of the sludge inlet;
   mixing the sludge and powder additive in the extruder;
   recovery of the sludge and powder additive mixture at the outlet of the extruder;
in which the powder additive feed flow is adjusted according to the sludge feed flow and in which the dwell time of the sludge in the extruder is less than 1 minute, in particular less than 45 seconds, more particularly less than 30 seconds.

### FIGURES

FIG. 1 is a schematic representation of the device according to the invention.

FIG. 2 is a representation of the co-rotating twin screws and the different conveyance and mixing zones.

FIG. 3 is a schematic representation of the position of the volumetric metering device in relation to the twin screw of the device according to the invention.

FIG. 4 is a three-dimensional graph of the grey level of each pixel of a scanned image of a sample of sludge treated with lime using the device according to the invention.

Device

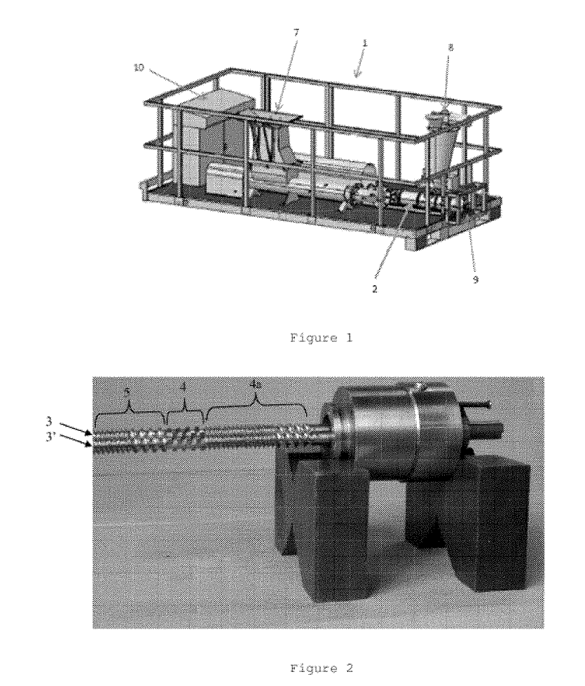

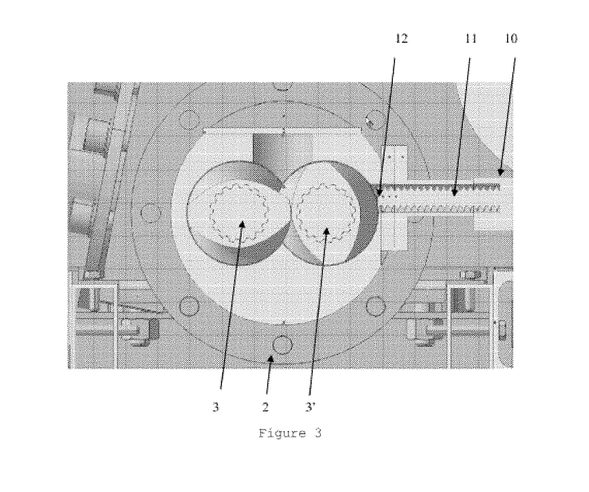

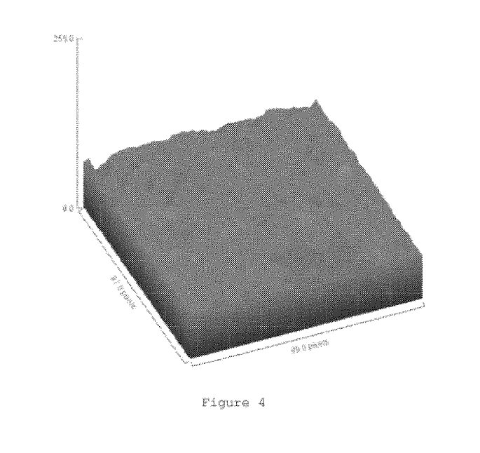

As shown in FIGS. 1 and 2, the device (1) of the present invention comprises a sleeve (2) with co-rotating twin screws.

The screws (3, 3′) of said sleeve (2) are totally interpenetrated co-rotating screws.

The screws (3, 3′) of the device according to the invention each have a length/diameter ratio of less than 20, preferably less than 14, more preferably less than 10, the length corresponding to the total length of the screw, expressed in mm, and the diameter corresponding to the nominal diameter of the screw, expressed in mm. This specific length/diameter ratio in fact allows a homogenous sludge and powder additive mixture to be obtained while achieving an optimum sized device.

Said screws consist of two or three successive zones. Thus, each zone comprises two segments of screws (3, 3′). Advantageously, the two or three zones can be easily assembled and dismantled. This in fact allows the maintenance costs to be limited when renewing the key parts of the mixing unit. Thus, each zone can consist of one or more modules that are fitted onto a shaft, for example a splined shaft advantageously allowing the modules to be connected to the shaft.

The first zone (4) ensures the mixing of the sludge and powder additive and the conveyance of said mixture to the second zone (5). The second zone (5) ensures the conveyance of the mixture of sludge and powder additive to the sleeve outlet.

The device of the invention may comprise a third zone (4a), located upstream of the first zone. Said third zone (4a) allowing the sludge to be conveyed from the sludge feed inlet to the first zone (4).

The purpose of the zone, namely to convey and/or mix material, is determined by the geometry of the segments of the screws (3, 3′) of each zone. In fact, a zone in which the threads of the two screws are in the direct direction, in other words the direction of travel of the threads is the same as the direction of rotation of the screws, allows the material to be conveyed. The pitch of the thread determines the conveying speed: the larger the pitch, the greater the conveying speed. A zone in which the threads are in the indirect direction, in other words the direction of travel of the threads is opposite the direction of rotation of the screws, allows the material to be mixed. In such a zone, an accumulation of material is observed with three-dimensional recirculations allowing very efficient mixing.

Thus, the segments of screws (3, 3′) of the second zone (5) and third zone (4a), if any, of the device (1) according to the invention have threads in the direct direction whereas the segments of screws (3, 3′) of the first zone (4) have threads in the indirect direction.

According to a particular embodiment, the first zone (4) comprises two modules, each module comprising 4 bilobes, each bilobe being offset by −30° in relation to the bilobe that precedes it.

According to a particular embodiment, the second zone (5) comprises two modules and possibly a die. The first module can in particular have a fast pitch in order to prevent the accumulation of material after the mixing zone. The second module can in particular have a slow pitch in order to slow down the material before the outlet of the device and thus achieve a maximum fill rate of the extruder. The rapid pitch and slow pitch can in particular be such as defined above. The die can in particular allow the material exiting the device according to the invention to be shaped.

According to a particular embodiment, the third zone (4a), if any, can comprise one, two or three modules. The modules can in particular have a fast pitch in order to prevent the accumulation of material in the device or a slow pitch. According to a particular embodiment, the fast pitch can in particular be a pitch of between 100 and 200 mm, in particular between 125 and 175 mm, more particularly between 140 and 160 mm. According to a particular embodiment, the slow pitch can in particular be a pitch of between 10 and 70 mm, in particular between 20 and 60 mm, more particularly between 30 and 50 mm.

The device (1) according to the invention also comprises a sludge feed inlet (6) emerging upstream of the first zone (4) or of the third zone (4a), if any, as well as a powder additive feed inlet (7) emerging at the first zone (4) or at the third zone (4a), if any. The mixture of sludge and powder additive is evacuated from the device (1) through an outlet (8) located downstream of the second zone (5).

According to a preferred embodiment, the sludge feed inlet (6) can comprise a sludge feed device. Said sludge feed device serves to deflocculate the sludge and ensure a constant flow in the sleeve (2). In fact, in order to optimize mechanical dewatering, flocculants are added to the sludge before liming. They give the sludge a lumpy and relatively sticky texture. The role of the sludge feed device is to break up these lumps in order to obtain a finer texture. This in fact facilitates the dispersal of the powder additive in the sludge and increases the exchange surface. The sludge feed device comprises, for example, a booster pump or a sleeve enclosing a single screw. This arrangement has the dual advantage of adjusting the flow of sludge entering the device and of deflocculating the sludge.

According to a particular embodiment, the sludge feed device comprises a booster pump. According to another particular embodiment, the sludge feed device comprises a sleeve enclosing a single screw.

According to a particular embodiment, the powder additive feed inlet (7) emerges at the first zone (4), more particularly, the powder additive feed inlet (7) is located at the end of the first zone furthest away from the outlet.

According to another embodiment, the powder additive feed inlet (7) emerges at the third zone (4a), if any. In this case, the powder additive feed inlet (7) is far from the first zone (4), in particular so as to prevent the formation of a plug. For example, the powder additive feed inlet (7) is located between ½ and ¾ along the length of the first zone (4a) in the conveying direction.

According to a preferred embodiment, said powder additive feed inlet (7) comprises a volumetric metering device, in particular a volumetric metering device (10) with twin co-rotating screws (11, 11′). The axes of rotation of the co-rotating twin screws (11, 11′) of the volumetric metering device (10) can in particular be perpendicular to the axes of rotation of the co-rotating twin screws (3, 3′) of the device (1) of the invention. Preferably, the ends (12, 12′) of the co-rotating twin screws (11, 11′) of the volumetric metering device (10) are flush with the co-rating twin screws (3, 3′) of the device (1) of the invention as shown in FIG. 4, More particularly, the ends (12, 12′) of the co-rotating twin screws (11, 11′) of the volumetric metering device (10) are located at least 0.5 cm, preferably at least 0.4 cm, more preferably at least 0.3 cm away from the co-rotating twin screws (3, 3′) of the device (1) of the invention. In fact, if the distance between said ends and said twin screws is greater than 0.5 cm, a plug can form in the sleeve, which blocks the volumetric metering device (10).

According to another embodiment, said powder additive feed inlet (7) comprises an Archimedes screw. This method of introduction is however less efficient that the volumetric metering device (10) which enables an excellent homogeneity and regularity of the metering of the powder additive.

According to a particular embodiment, the Archimedes screw ensuring the powder additive feed has a pitch of between 10 and 50 mm, in particular between 20 and 40 mm, more particularly between 25 and 35 mm.

The device according to the invention also comprises a control means (9) allowing the powder additive feed flow to be adjusted according to the sludge feed flow and the desired quantity of powder additive to be incorporated into the sludge. Thus, the control means (9) can in particular comprise a means allowing the flow at the sludge feed inlet (6) to be determined, a means for controlling the speed of rotation of the screws (3, 3′) of the sleeve (2) as well as a means allowing the flow at the powder additive feed inlet (7) to be controlled. For example, a torque sensor can be fixed onto the shaft of the single screw of the sludge feed device (6). The measurement of the torque associated with the pitch of said single screw allows the calculation of the sludge feed flow at the inlet of the device as well as the speed of rotation of the co-rotating twin screws (3, 3′) of the device (1) and the speed of rotation of the Archimedes screw or the twin screws (11, 11′) of the volumetric metering device (10) feeding the device with powder additive.

The sleeve (2) and the two screws (3, 3′) form a mixing device akin to a co-rotating twin-screw extruder as found in the field of the treatment of plastics materials. Significant differences are, however, the geometry of the twin screw (succession of different zones), the absence of heating of the sleeve (which is not necessary in the case of sludge) and the presence of a feed inlet for powder additive such as lime.

Method

The method that forms the subject matter of the invention is a method for the treatment of sludge with a powder additive by extrusion.

The method according to the invention is implemented by introducing sludge into a co-rotating twin-screw extruder then introducing a powder additive into the extruder downstream of the sludge inlet. The powder additive feed flow is adjusted according to the sludge feed flow. The sludge and the powder additive are then mixed and said mixture is recovered at the outlet of the extruder. The dwell time of the sludge in the extruder is less than 1 minute, in particular less than 45 seconds, more particularly less than 30 seconds. The dwell time of the sludge can notably be more than 7 seconds, in particular more than 15 seconds, more particularly more than 22 seconds.

The method according to the invention can notably be implemented with the device (1) of the invention described above. All of the characteristics of the device (1) of the invention therefore apply to the method according to the invention.

Preferably, the sludge is deflocculated before being introduced into the extruder. Deflocculation can notably be achieved with a single screw or a booster pump as described above. Advantageously, the single screw or the booster pump of the deflocculation step directly conveys the sludge towards the sludge feed inlet (6) of the extruder (1). This notably allows the sludge flow entering into the method to be adjusted according to the speed of rotation and the pitch of the single screw used for deflocculation.

The sludge entering into the method according to the invention can notably have a dry matter content of between 15 and 30%, in particular between 20 and 25% by weight in relation to the weight of the sludge.

The powder additive is introduced into the extruder downstream of the sludge feed inlet (6). According to a preferred embodiment, the powder additive is fed into the inlet (7) during the mixing step. This embodiment is used when the device (1) of the invention comprises two zones.

According to another embodiment, the powder additive is fed into the inlet (7) before the mixing step. This embodiment is used when the device (1) of the invention comprises three zones.

The powder additive entering into the method according to the invention can notably be lime or dry sludge.

According to a preferred embodiment, the powder additive is lime. This embodiment allows the sludge to be limed so as to hygienize it. The lime can in particular be quicklime and predominantly contains calcium oxide (CaO). When the quicklime comes into contact with the water contained in the sludge, an exothermic reaction leads to the formation of slaked lime, i.e. calcium hydroxide (Ca(OH)₂). The lime used can notably have a grain size of between 10 and 200 micrometers.

According to a particular embodiment, the ratio between the mass of lime and the total mass of lime and sludge introduced into the sleeve is less than 35%, in particular less than 30%, more particularly less than 25%, and even more particularly less than 20%. Such a dose is sufficient to obtain a treated sludge that meets health requirements because the quality of the mixture is far superior to that achieved by adopting current methods.

According to a particular embodiment, the powder additive is dried sludge. This embodiment allows the dryness of the sludge to be increased so as to make it less sticky and easier to use.

According to a particular embodiment, the ratio between the mass of dry sludge and the total mass of dry sludge and sludge introduced into the sleeve is between 20% and 60%, in particular between 25% and 50%.

According to a particular embodiment, the flow of sludge treated using the method of the invention is greater than 500 kg/hour, in particular greater than 750 kg/h, more particularly greater than 900 kg/hour.

According to a particular embodiment, the flow of lime is between 15 and 150 kg/h, in particular between 30 and 125 kg/h, more particularly between 60 and 100 kg/h.

The degree of homogeneity of the mixture obtained at the outlet (8) of the extruder can be linked to the flatness of the topographical surface of the grey levels measured in a scanned image of the mixture as described in the grey level test below. The method according to the invention can notably allow a variance in the grey level of the topographic surface of less than 20%, in particular less than 15%, more particularly less than 10% to be achieved.

Although the invention has been described in connection with a particular embodiment, clearly it is in no way limited and includes all of the technical equivalents of the means described as well as their combinations if these fall within the scope of the invention.

The invention will be described in more detail with the aid of the following figures and examples, which are given purely by way of illustration.

### EXAMPLES

Methods of Measurement

The degree of homogeneity of the mixture is measured by analyzing a scanned image of a sample of sludge treated according to the invention with lmageJ software, freely available on the internet. This software allows the grey level of each pixel of the scanned image to be measured and the variance in the grey level for the sample to be calculated by applying the formula:

$$V ( X ) = \frac{1}{n} {\sum }_{i = 1}^{n} {( {x}_{i} - m )}^{2} .$$

where

V(X) is the variance;

n is the number of pixels;

xi represents the value of the grey level of each pixel i;

m represents the mean of the xi values with i being an integer ranging from 1 to n.

### Example 1

The sludge is treated with lime in a device (1) comprising a sleeve (2) enclosing two co-rotating screws (3, 3′) each having a length of 0.75 m and a nominal diameter of 80 mm. The L/D ratio of the device is 9.375.

Each screw comprises a first mixing zone (4), a second conveying zone (5) located downstream of the first zone and a third zone (4a) located upstream of the first zone.

The first zone (4) comprises two successive modules, each module comprising 4 bilobes, each bilobe being offset in relation to the preceding bilobe by −30°.

The second zone (5) comprises two successive modules, the first module having a pitch of 150 mm and the second module having a pitch of 40 mm.

The third zone (4a) comprises a module having a pitch of 40 mm.

The device is fed with sludge at a flow rate of 650 kg/hour. The sludge entering the device (1) has a dry matter content of 22% and is pushed through by a feed device comprising a 0.8-2 m³/h monobloc eccentric-rotor booster pump (Model 25GVA6, manufactured by PCM).

The device is fed with lime at a flow rate of 43 kg/hour. The lime entering the device (1) is pushed through by a volumetric metering device (10) with co-rotating twin screws (11, 11′). The twin screws (11, 11′) have a length of 1300 mm, a nominal diameter of 78.5 mm and a pitch of 75 mm. The lime enters the device at the third zone (4a). The axes of rotation of the co-rotating twin screws (11, 11′) of the volumetric metering device (10) are perpendicular to the axes of rotation of the two co-rotating screws (3, 3′) of the device (1) of the invention. The ends (12, 12′) of the co-rotating twin screws (11, 11′) of the volumetric metering device (10) are located at 0.2 cm from the co-rotating twin screws (3, 3′) of the device (1) of the invention.

The mixture of sludge and lime is recovered at the outlet (8) of the device. The lime distributed within the sludge reacts with the water contained in the sludge, which leads to an increase in temperature and the destruction of microorganisms.

FIG. 4 shows that the mixture of sludge and lime obtained at the outlet of the device (1) is homogenous. In fact, the scanned image of a sample of sludge treated by lime as described above has a relatively flat topographical surface of the grey levels.

1. A device for the treatment of sludge with a powder additive, said device comprising:
a sleeve enclosing two co-rotating screws, said screws of said sleeve consisting of two or three successive zones: the first zone ensuring the mixture of the sludge and powder additive; the second zone ensuring the conveyance of the mixture of sludge and powder additive; the third zone located upstream of the first zone, ensuring the conveyance of the sludge from the sludge feed inlet to the first zone;
a sludge feed inlet emerging upstream of the first zone or third zone, if any;
a powder additive feed inlet emerging at the first zone or third zone, if any;
an outlet for the mixture of sludge and powder additive downstream of the second zone;
a control means allowing the powder additive feed flow to be adjusted according to the sludge feed flow;
said device having a length/diameter ratio of less than 20.

2. A device according to claim 1, characterized in that the powder additive feed inlet comprises a volumetric metering device.

3. A device according to claim 2, characterized in that the volumetric metering device is a volumetric metering device with co-rotating twin screws.

4. A device according to claim 3, characterized in that the ends of the co-rotating twin screws of the volumetric metering device are located at least 0.5 cm away from the co-rotating twin screws of the device.

5. A method for the treatment of sludge by extrusion characterized in that it comprises the following steps:
introduction of sludge into a co-rotating twin-screw extruder;
introduction of a powder additive in the extruder downstream of the sludge inlet;
mixing the sludge and powder additive in the extruder;
recovery of the sludge and powder additive mixture at the outlet of the extruder;
in which the powder additive feed flow is adjusted according to the sludge feed flow and in which the dwell time of the sludge in the extruder is less than 1 minute.

6. A method according to claim 5, characterized in that the treatment of the sludge by extrusion is performed
using a device comprising:
a sleeve enclosing two co-rotating screws, said screws of said sleeve consisting of two or three successive zones: the first zone ensuring the mixture of the sludge and powder additive; the second zone ensuring the conveyance of the mixture of sludge and powder additive; the third zone located upstream of the first zone, ensuring the conveyance of the sludge from the sludge feed inlet to the first zone;
a sludge feed inlet emerging upstream of the first zone or third zone, if any;
a powder additive feed inlet emerging at the first zone or third zone, if any;
an outlet for the mixture of sludge and powder additive downstream of the second zone;
a control means allowing the powder additive feed flow to be adjusted according to the sludge feed flow;
said device having a length/diameter ratio of less than 20.

7. A method according to claim 5, characterized in that the flow of sludge treated is greater than 500 kg/hour.

8. A method according to claim 5, characterized in that the sludge is defiocculated before being introduced into the extruder.

9. A method according to claim 5, characterized in that the powder additive is lime.

10. A method according to claim 9, characterized in that the ratio between the mass of lime and the total mass of lime and sludge introduced into the sleeve is less than 35%.

11. A method according to claim 5, characterized in that the powder additive is dry sludge.

12. A method according to claim 5, characterized in that the scanned image of the sludge exiting the extruder has a variance of the grey level of the topographic surface of less than 20%.

13. A method according to claim 6, characterized in that the flow of sludge treated is greater than 500 kg/hour.

14. A method according to claim 13, characterized in that the sludge is deflocculated before being introduced into the extruder.

15. A method according to claim 14, characterized in that the powder additive is lime.

16. A method according to claim 15, characterized in that the ratio between the mass of lime and the total mass of lime and sludge introduced into the sleeve is less than 35%.

17. A method according to claim 16, characterized in that the powder additive is dry sludge.

18. A method according to claim 17, characterized in that the scanned image of the sludge exiting the extruder has a variance of the grey level of the topographic surface of less than 20%.
